(19) United States
(12) Patent Application Publication
(10) Pub. No.: US 2023/0004302 A1
(43) Pub. Date: Jan. 5, 2023

(54) Apparatus, Device, Method, and Computer Program for Managing Memory of a Computer System

(71) Applicant: Intel Corporation, Santa Clara, CA (US)

(72) Inventors: Sajjid REZA, Chandler, AZ (US); Baohong LIU, FREMONT, CA (US)

(21) Appl. No.: 17/931,904

(22) Filed: Sep. 14, 2022

(51) Int. Cl. G06F 3/06

(52) U.S. Cl. CPC G06F 3/0611; G06F 3/0679; G06F 3/0653

(57) ABSTRACT

Examples relate to an apparatus, a device, a method, and computer program for managing memory of a computer system, and to a computer system comprising such an apparatus or device. The apparatus is configured to obtain first information on accesses to at least one of a first tier of memory and a second tier of memory within a memory hierarchy of the computer system from a page table, the first and second tiers of memory being below the processor cache tiers of the memory hierarchy, the first tier of memory having a higher memory performance than the second tier of memory. The apparatus is configured to obtain second information on accesses to at least one of the first tier of memory and the second tier of memory from logged processor events related to the accesses to the first tier of memory and the second tier of memory. The apparatus is configured to select one or more memory pages to be moved between the first tier of memory and the second tier of memory based on the first and second information on the accesses to at least one of the first tier of memory and the second tier of memory.

### FIELD

Examples relate to an apparatus, a device, a method, and computer program for managing memory of a computer system, and to a computer system comprising such an apparatus or device.

### BACKGROUND

The concept of memory tiering is increasingly being used, in view of increasing cost of memory as well as platform DRAM (Dynamic Random Access Memory) capacity limitations. Intel® persistent memory (PMEM), NVMe (Non-Volatile Memory express) and soon to be available CXL (Compute Express Link)-attached memory provide a slightly slower and cheaper memory tier with a large additional capacity. Different Operating System (OS)/Hypervisor vendors are already working to provide memory tiering solutions. For example, some vendors of hypervisor software envision a software-defined memory implementation that will aggregate tiers of different memory types such as DRAM, PMEM, NVMe and other future technologies in a cost-effective manner, to deliver a uniform consumption model that is transparent to applications.

### BRIEF DESCRIPTION OF THE FIGURES

Some examples of apparatuses and/or methods will be described in the following by way of example only, and with reference to the accompanying figures, in which

FIG. 1a shows a block diagram of an example of an apparatus or device for managing memory of a computer system, and of a computer system comprising such an apparatus or device;

FIG. 1b shows a flow chart of an example of a method for managing memory of a computer system;

FIG. 2 shows a diagram of a categorization of memory accesses from a server-side java workload;

FIG. 3 shows a diagram highlighting sparsity of accesses for large pages (2M) from a server-side java workload;

FIG. 4 shows a table of potential information to be collected for respective memory pages; and

FIG. 5 shows a schematic diagram of an example flow of hot/cold page selection for migration for memory tiering scenarios.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e., only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

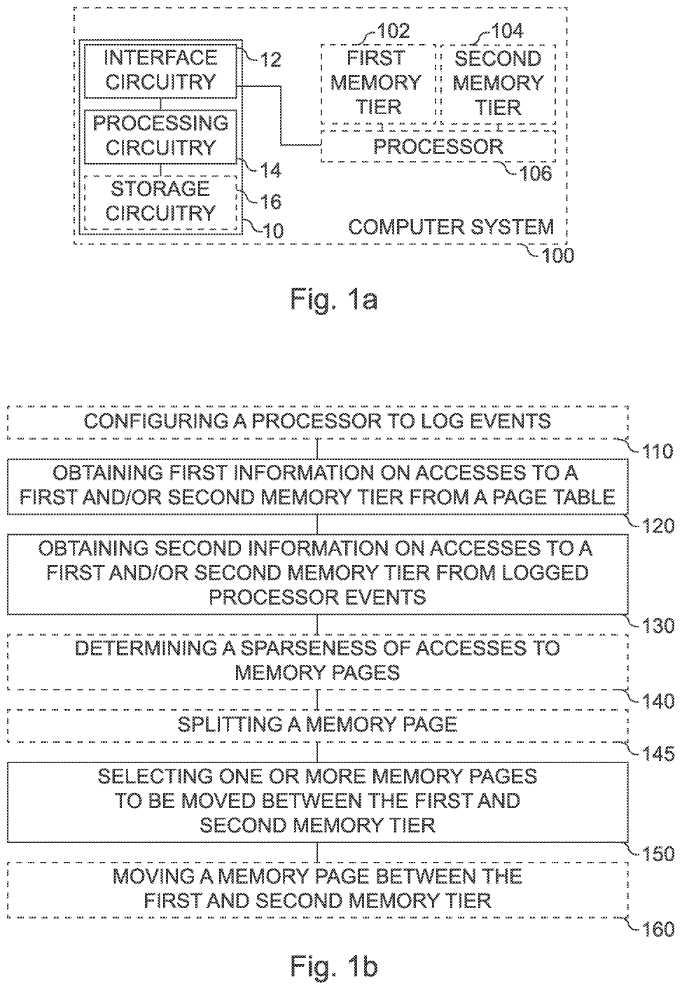

FIG. 1a shows a block diagram of an example of an apparatus 10 or device 10 for managing memory of a computer system 100. The apparatus 10 comprises circuitry that is configured to provide the functionality of the apparatus 10. For example, the apparatus 10 of FIGS. 1a and 1b comprises interface circuitry 12, processing circuitry 14 and (optional) storage circuitry 16. For example, the processing circuitry 14 may be coupled with the interface circuitry 12 and with the storage circuitry 16. For example, the processing circuitry 14 may be configured to provide the functionality of the apparatus, in conjunction with the interface circuitry 12 (for exchanging information, e.g., with other components inside or outside a computer system 100 comprising the apparatus or device 10, such as a first 102 and/or a second tier of memory 104 and/or a processor 106 (e.g., a central processing unit) of the computer system) and the storage circuitry (for storing information, such as machine-readable instructions) 16. Likewise, the device 10 may comprise means that is/are configured to provide the functionality of the device 10. The components of the device 10 are defined as component means, which may correspond to, or implemented by, the respective structural components of the apparatus 10. For example, the device 10 of FIGS. 1a and 1b comprises means for processing 14, which may correspond to or be implemented by the processing circuitry 14, means for communicating 12, which may correspond to or be implemented by the interface circuitry 12, and (optional) means for storing information 16, which may correspond to or be implemented by the storage circuitry 16. In general, the functionality of the processing circuitry 14 or means for processing 14 may be implemented by the processing circuitry 14 or means for processing 14 executing machine-readable instructions. Accordingly, any feature ascribed to the processing circuitry 14 or means for processing 14 may be defined by one or more instructions of a plurality of machine-readable instructions. The apparatus 10 or device 10 may comprise the machine-readable instructions, e.g., within the storage circuitry 16 or means for storing information 16.

The processing circuitry 14 or means for processing 14 is configured to obtain first information on accesses to at least one of the first tier of memory 102 and the second tier of memory 104 within a memory hierarchy of the computer system from a page table. The first and second tiers of memory are below the processor cache tiers of the memory hierarchy. The first tier of memory has a higher memory performance than the second tier of memory. The processing circuitry 14 or means for processing 14 is configured to obtain second information on accesses to at least one of the first tier of memory and the second tier of memory from logged processor events related to the accesses to the first tier of memory and the second tier of memory. The processing circuitry 14 or means for processing 14 is configured to select one or more memory pages to be moved between the first tier of memory and the second tier of memory based on the first and second information on the accesses to at least one of the first tier of memory and the second tier of memory.

FIG. 1a further shows the computer system 100 comprising such an apparatus or device. The computer system further comprises the memory hierarchy with the first 102 and the second 104 tier of memory, and a processor 106, e.g., a central processing unit. For example, the processor 106 may correspond to the processing circuitry 14 or means for processing 14. Alternatively, the processor 106 may be separate from the processing circuitry 14 or means for processing 14.

FIG. 1b shows a flow chart of an example of a corresponding method for managing the memory of the computer system 100. The method comprises obtaining 120 the first information on accesses to at least one of the first tier of memory 102 and the second tier of memory 104 within a memory hierarchy of the computer system from the page table. The method comprises obtaining 130 the second information on accesses to at least one of the first tier of memory and the second tier of memory from the logged processor events related to the accesses to the first tier of memory and the second tier of memory. The method comprises selecting 150 the one or more memory pages to be moved between the first tier of memory and the second tier of memory based on the first and second information on the accesses to at least one of the first tier of memory and the second tier of memory. For example, the method may be performed by the computer system 100 (e.g., by the apparatus 10 or device 10 of the computer system 100).

In the following, the features of the apparatus 10, the device 10, the computer system 100, the method and computer program are illustrated in more detail in connection with the apparatus 10 and computer system 100. Features illustrated in connection with the apparatus 10 and/or computer system 100 may likewise be included in the corresponding device 10, method and computer program.

Various examples of the present disclosure relate to the management of memory in computer systems with multiple tiers of memory. In many computer systems, the presence of multiple tiers of memory has been common for many years. In general, the memory hierarchy of a computer system comprises the various registers of the processor (i.e., Central Processing Unit, CPU) of the computer system, then one or more levels of cache of the processor (L1 cache, L2 cache, L3 cache etc.), followed by the Random Access Memory (RAM) and the storage (e.g., hard drives or flash-based storage) of the computer system. In such computer systems, programs and data are loaded from the storage into the RAM, and then, during execution, portions of the programs and data stored in the RAM are cached in the respective cache levels of the processors and/or loaded into the registers of the CPU as required by the operations being performed. In this memory hierarchy, each of the levels (apart from the levels of cache of the CPU) serves a different purpose, with mechanisms in place to move memory between the different tiers of memory.

The proposed system relates to computer systems, where this well-known memory hierarchy is extended by having two tiers of memory between the CPU cache and the storage—the aforementioned first tier of memory and second tier of memory. As described above, the first and second tiers of memory sit below the processor cache tiers of the memory hierarchy. Moreover, as they are tiers of memory (and not storage), they are also above the storage tier or tiers of the memory hierarchy. In other words, the first and second tier of memory are between the CPU cache levels of the memory hierarchy and the storage tier(s) of the memory hierarchy. For example, the first and second tier of memory may be memory tiers, i.e., they might not be storage tiers of the memory hierarchy. While at least the second tier of memory may be based on persistent memory (i.e., memory that persists across power cycles), their performance (i.e., in terms of data transmission bandwidth/throughput and latency) may be on par (or only slightly lower) than random access memory that is part of the computer system. For example, the first tier of memory may be dynamic random-access memory (DRAM)-based memory. The second tier of memory may be one or persistent memory, non-volatile memory express (NVMe)-based memory (i.e., memory that is accessed via the NVMe interface instead of the memory bus of the computer system), and compute express link (CXL)-based memory (i.e., memory that is accessed via the CXL interface instead of via the memory bus). Accordingly, the first tier of memory has a higher memory performance (in terms of data transmission bandwidth/throughput and/or latency) than the second tier of memory. The second tier of memory may be inherently slower (i.e., have a lower data transmission bandwidth or throughput) and/or have a higher latency (due to being connected via a different interconnect, such as NVMe or CXL, than the DRAM of the first tier of memory). In various examples, the memory capacity (e.g., in terms of Gigabytes or memory) of the second tier of memory may be larger than the memory capacity of the first tier of memory.

These different tiers of memory can affect the performance of computer programs being executed on the computer system. If a computer program often has to access data and/or instructions in the second tier of memory, the computer program may be sped up by moving the data and/or instructions to the first tier of memory (having the better memory performance). However, the amount of memory that is part of the first tier of memory is limited, so that when a computer program needs access to large sets of data (e.g., large in-memory databases), it may be infeasible to fit all of the data in the first tier of memory.

The proposed concept deals with the decision on which data being used by the computer programs executed by the computer system is to reside in the first tier of memory and which data is to reside in the second tier of memory.

In practice, data or instructions that are often accessed by the computer programs being executed on the computer system are most likely to benefit from being stored in the first tier of memory. Most computer architectures use so-called page tables to translate between virtual addresses and physical addresses, with the virtual addresses being used by the computer programs the physical addresses being used by the actual hardware of the computer system. The memory is being addressed with the granularity of so-called pages, with different page-sizes being supported (such as pages having a size of 4 Kilobytes, of 2 Megabytes, or of 1 Gigabyte). Page tables have a plurality of page table entries, with each entry comprising information on the mapping between the respective virtual address and the corresponding physical address, and auxiliary information on the page. In particular, such auxiliary information comprises a so-called “access” (A) bit and a “dirty” (D) bit. For example, the first information on the accesses may be based on the respective access bits (A) and dirty bits (D) stored in the page table. The access bit indicates whether the software has accessed the page, and the dirty bit indicates whether software has written to the page. These bits can be used to determine whether a page is actively being used. In some systems, the respective bits may be reset periodically (e.g., after the “dirty” page has been written to storage in case of swapping being used) to determine the “hotness” of the page, i.e., whether a page is repeatedly being accessed. Some approaches rely solely on this “hotness” of the page to determine which pages are to reside in the first tier of memory and which are to reside in the second tier of memory”. However, in many cases, such an approach may be inexact, as pages that are often accessed also reside in one of the cache levels of the CPU—in these cases, the access and/or dirty bits are also set even when the pages have been accessed via one of the cache levels of the CPU. Moving such pages to the first tier of memory would have little benefit (or be even detrimental, due to the overhead of doing so).

In the proposed concept, apart from the information gained from the page table (which may be the Page Table or the Enhanced Page Table of the computer system), additional information gained from so-called processor events is used to perform the selection on which pages are to reside in the first and which pages are to reside in the second tier of memory. In some examples, this selection may be performed as a (continuous) system-level optimization tasks, with daemons being used to (continuously) monitor the memory accesses performed by the computer programs being executed on the computer systems. In other words, the first information and the second information on the accesses may relate to accesses of different computer programs or virtual machines being executed on the computer system. In some examples, however, the proposed concept may be applied on memory accesses of a specific computer program or virtual machine (comprising computer programs being executed within the virtual machine). In other words, the first information and the second information on the accesses may relate to accesses of a specific computer program (or virtual machine) being executed by the computer system.

To setup the computer system for the proposed concept, the processor of the computer system may be configured to perform the monitoring of the relevant processor events. For example, the processing circuitry may be configured to configure (i.e., instruct) the processor 106 of the computer system to log the events of interest, e.g., at least one of a memory access latency of accesses to memory pages and a processor cache hit or miss rate of accesses to memory pages. Correspondingly, as further shown in FIG. 1b, the method may comprise configuring 110 the processor 106 of the computer system to log at least one of a memory access latency (e.g., in milliseconds or clock cycles) of accesses to memory pages and a processor cache hit or miss rate (e.g., of the L3 cache of the processor) of accesses to memory pages. For example, as outlined above, the processing circuitry may be configured to configure the processor of the computer system to log at least one of the memory access latency of accesses to memory pages and the processor cache hit or miss rate of accesses to memory pages for a specific computer program being executed by the computer system. Accordingly, the logged processor events may comprise information on processor cache hits or misses occurring during accesses to the first tier of memory and the second tier of memory and/or information on a latency of accesses to memory pages stored in at least one of the first tier of memory and the second tier of memory. For example, the processor may be instructed to log the memory accesses (at least with respect to the memory pages of a specific computer program being executed by the computer system) using the processor event-based logging functionality of the processor, e.g., in a debug store, which is a portion of memory. For example, the processor may be instructed to log a first type of event for each memory access, and a second type of event every time a memory access is not satisfied by the processor cache. Along with the mere presence of a memory access not satisfied by the processor cache, the latency of the memory access may be logged by the processor, so that the impact of memory access to memory of the first tier and to memory of the second tier can be analyzed in post-processing. Accordingly, the information on the latency of the accesses to the memory pages may reflect the cache hits or misses occurring during accesses to at least one of the first tier of memory and the second tier of memory.

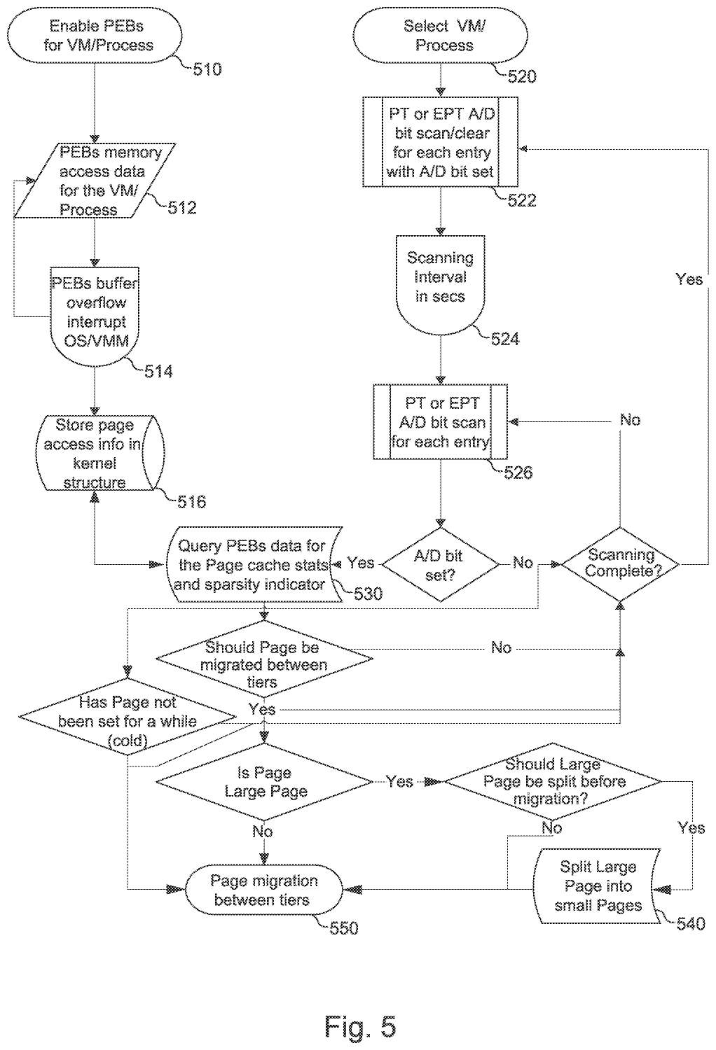

The processing circuitry 14 is configured to obtain the first information on the accesses to at least one of the first tier of memory 102 and the second tier of memory 104 from the page table, and to obtain the second information on the accesses to at least one of the first tier of memory and the second tier of memory from the logged processor events, and use both the first and the second information to perform the selection of which pages are to reside in the first tier of memory and which pages are to reside in the second tier of memory. In general, the first information (e.g., the A/D bits) and the second information (e.g., the information on the latency and/or cache misses of the memory accesses) can be combined in various ways to perform the selection process. For example, the processing circuitry may be configured to select the one or more memory pages to be moved between the first tier of memory and the second tier of memory based on at least one of an access frequency of the one or more memory pages, a memory access latency of accesses to the one or more memory pages and a processor cache hit or miss rate of accesses to the one or more memory pages. For example, the processing circuitry may be configured to, if the second information on the accesses indicates, that an access to a memory pages has a latency above a threshold (and is therefore likely stored in the second tier of memory and does not reside in one of the processor cache levels), the first information on the accesses can be used to make sure that this page is accessed frequently (e.g., more frequently than an access frequency threshold) before this page is selected to be moved from the second tier of memory to the first tier of memory. In some examples, as shown in FIG. 5, for example, the process operates the other way round. For example, first, the “hotness” of the respective pages is determined. If a page resides in the second tier of memory and is considered hot (i.e., the A and/or D bits are frequently set after a reset of the A/D bits), the second information on the accesses may be checked to determine whether the page does not reside in one of the processor cache levels (based on the latency of the accesses and/or based on the access triggering a cache miss on the processor cache levels). If both conditions are true, i.e., if the first information indicates that the page is hot (i.e., frequently accessed) and does not reside in the processor cache (at least a pre-determined ratio of the accesses), the page may be selected to be moved to the first tier of memory. In other words, the processing circuitry may be configured to select a memory page to be moved from the second tier of memory to the first tier of memory if a) the first and second information on the accesses indicate the access frequency to the memory page is higher than an access frequency of at least some other memory pages, and b) the processor cache miss rate of accesses to the memory page is higher than a pre-defined cache miss threshold or c) the memory access latency of accesses to the memory page is higher than a pre-defined latency threshold (conditions b) and c) both indicate that the memory page is frequently accessed in the second tier of memory and not in the processor cache).

In the present disclosure, the focus has been on selecting memory pages to be moved from the second tier of memory to the first tier of memory, e.g., when the respective pages are considered hot (due to the A/D bit being set and the processor events indicate a performance hit, as the page is not being cached in a processor cache). However, the same mechanism may be employed for pages that are stored in the first tier of memory and that are considered cold (e.g., due to their A/D bit not or infrequently being set). Such cold pages currently stored in the first tier of memory may be selected for migration from the first memory tier to the second memory tier. For example, the processing circuitry may be configured to select a memory page to be moved from the first tier of memory to the second tier of memory if the first information on the accesses indicate the access frequency to the memory page is lower than an access frequency of at least some other memory pages.

Once the selection is performed, the respective page or pages may be moved to the second tier. In other words, the processing circuitry may be configured to move a memory page between the second tier of memory and the first tier of memory (e.g., from the second tier to the first tier in case of a page being considered hot, and from the first tier to the second tier in case of page being considered cold) based on the selection. Accordingly, as further shown in FIG. 1b, the method may comprise moving 160 a memory page between the second tier of memory and the first tier of memory based on the selection. Other pages (i.e., pages not being selected, as they are considered to be “cold” as they are not or only infrequently access) may be moved from the first tier to the second tier in exchange for the aforementioned movement of the selected memory page or pages.

In some examples, a memory page may reside in the second tier of memory and may be frequently accessed, but only few bits (or bytes) of the pages might only be used. For example, if large or huge pages are used (e.g., pages with 2 megabytes or 1 Gigabyte of memory), but the information being accessed is only few kilobytes of size, it may be suboptimal to move the entire large page to the first tier of memory. Moreover, the page size may also inhibit the pages from being cached by the processor cache. In some examples of the present disclosure, accesses to such memory pages may be analyzed to determine whether a large page being accessed is read in its entirety, or whether only small portions of the page are being used. This property of accesses to the memory is in the following called the “sparseness” of accesses to the respective memory page and is further illustrated in connection with FIG. 3.

For example, a first subset of the memory pages of the memory may have a first smaller page size (e.g., 4 Kilobytes) and a second subset of the memory pages of the memory have a second larger page size (e.g., 2 Megabytes or 1 Gigabyte). The processing circuitry may be configured to determine the sparseness of accesses to the memory pages having the second larger page size. Accordingly, as further shown in FIG. 1b, the method may comprise determining 140 a sparseness of accesses to the memory pages having the second larger page size. For example, the sparseness of the accesses may indicate a ratio of bits of the memory page being accessed compared to the page size. For example, the sparseness may be represented as a floating-point number (of the ratio), or as a binary indicator (sparsely accessed vs. most bits are accessed) or enumeration (sparsely accessed, a medium number of bits are accessed, or most bits are accessed). The processing circuitry may be configured to split a memory page having the second larger page size into a plurality of memory pages having the first smaller page size based on the sparseness of accesses to the memory page (e.g., if the sparseness indicates that the ratio is smaller than a sparseness threshold or that the memory pages is sparsely accessed). Accordingly, as further shown in FIG. 1b, the method may comprise splitting 145 a memory page having the second larger page size into a plurality of memory pages having the first smaller page size based on the sparseness of accesses to the memory page. In some examples, the decision on whether to split the memory page having the second larger page size and the selection of the at least one memory page may be based on the first and/or second information on the accesses. For example, the processing circuitry may be configured to split the memory page if the page is considered hot and does not (often) reside in the processor cache. The processing circuitry may then be configured to only select one or more of the smaller memory pages for moving to the first memory tier. In other words, the processing circuitry may be configured to select at least one of the plurality of memory pages having the first smaller page size to be moved between the first tier of memory and the second tier of memory. Accordingly, as further shown in FIG. 1b, the method may comprise selecting 150 least one of the plurality of memory pages having the first smaller page size to be moved between the first tier of memory and the second tier of memory.

The interface circuitry 12 or means for communicating 12 may correspond to one or more inputs and/or outputs for receiving and/or transmitting information, which may be in digital (bit) values according to a specified code, within a module, between modules or between modules of different entities. For example, the interface circuitry 12 or means for communicating 12 may comprise circuitry configured to receive and/or transmit information.

For example, the processing circuitry 14 or means for processing 14 may be implemented using one or more processing units, one or more processing devices, any means for processing, such as a processor, a computer or a programmable hardware component being operable with accordingly adapted software. In other words, the described function of the processing circuitry 14 or means for processing may as well be implemented in software, which is then executed on one or more programmable hardware components. Such hardware components may comprise a general-purpose processor, a Digital Signal Processor (DSP), a micro-controller, etc.

For example, the storage circuitry 16 or means for storing information 16 may comprise at least one element of the group of a computer readable storage medium, such as a magnetic or optical storage medium, e.g., a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

For example, the computer system 100 may be a workstation computer system (e.g., a workstation computer system being used for scientific computation) or a server computer system, i.e., a computer system being used to serve functionality, such as the computer program, to one or client computers.

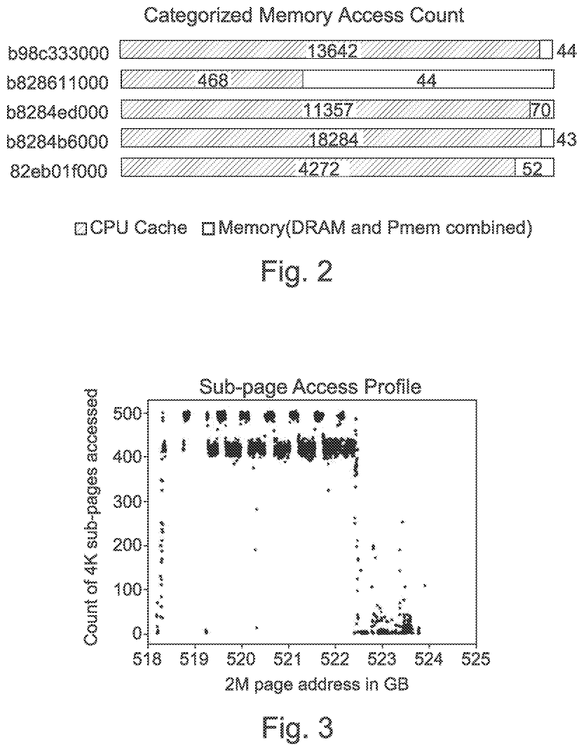

More details and aspects of the apparatus 10, device 10, computer system 100, method and computer program are mentioned in connection with the proposed concept, or one or more examples described above or below (e.g., FIGS. 2 to 5). The apparatus 10, device 10, computer system 100, method and computer program may comprise one or more additional optional features corresponding to one or more aspects of the proposed concept, or one or more examples described above or below.

Various examples of the present disclosure relate to a concept for efficient hot and cold page tracking by combining page table entry A (Accessed) and/or D (Dirty) bit tracking with memory access data from processor event-based sampling for software memory tiering.

In memory tiering scenarios with a slower and a faster memory tier, it may be considered important to keep the active and hot pages in the faster tier and move inactive or cold pages to the slower tier in case of memory pressure on the faster tier. The most common mechanism available to detect hot and cold pages is to use PTE (Page Table Entries) A/D (Accessed/Dirty) bits, e.g., from the x86-64 page table or from the EPT (Expanded Page Table) page table for virtualization. In such a mechanism, either A or D or both bits of all page table entries are scanned and cleared and then rescanned after a preset interval to detect any PTE that has the has A/D bit(s) set. If the A/D bit(s) are set, then the page is considered to be active and hot. Otherwise, the page is considered cold. If a page that currently resides in a slower tier turns out to be very active or hot, then that page may be remapped to the faster tier and its data may be copied to the new page in faster tier. However, as will become evident in the following, this may lead to a suboptimal selection of pages for migration, leading to suboptimal performance in memory tiering scenarios.

However, in this approach, whether or not the content of page is already stored in the processor cache hierarchy is not factored in. If it turns out that actual data footprints mostly reside in cache, then remapping such pages from the slower tier to the faster tier may not lead to any performance improvement, but rather cost memory bandwidth. As shown in FIG. 2, some pages are having most of their accesses retired in cache hierarchy. FIG. 2 shows a diagram of a categorization of memory accesses from a server-side java workload. The diagram distinguishes between memory accesses served by the CPU (Central Processing Unit) cache (the darker portion of the graphs of the left) and the memory accesses served by the memory (DRAM and PMEM combined). As can be seen, in many cases, more than 90% of memory accesses are served by the CPU cache accesses.

If the page happens to be a large page (e.g., a 2 Megabyte page) but only sparsely accessed, then remapping such a large page may incur a (mostly) useless large amount of memory copying overhead from the slower tier to the faster tier, which may overshadow any benefits of having the page in the faster tier. Sparsity of accesses for large pages (2 MB) from server-side java workload, as captured using processor event-based sampling, is shown in FIG. 3. FIG. 3 shows a diagram highlighting sparsity of accesses for large pages (2M) from a server-side java workload. In FIG. 3, the x-axis shows the 2M page address (in GB), and the y-axis shows the count of 4K sub-pages (of the respective 2M page) that are addressed. On the right, a large number of 2M pages are shown that are only sparsely accessed (i.e., between 0 and 50 4K pages of the 2M page) It is evident that, with some 2M pages, accesses are concentrated on a few 4K blocks within the large pages indicating these large pages potentially could be split into small pages helping memory tiering solution.

If the page happens to be large page (e.g., a 2M page), but has only been sparsely accessed in the past, then remapping such a large page may incur a useless large amount of memory copy overhead from the faster tier to the slower tier.

To address the above drawbacks, in the present disclosure, A/D bit scanning is augmented with memory access data from processor event-based sampling, e.g., using memory latency events to identify hot pages residing in a slower tier that would benefit from being remapped to the faster tier. In some examples, the sparsity of large pages is measured, to avoid unnecessary data movement without any performance improvement.

The proposed concept may improve hot/cold page tracking in memory tiering scenarios by combining page table A/D bit tracking and memory access tracking using processor event-based sampling, which is a capability modern CPU architectures, e.g., from Intel® have. For example, Intel® processor event-based sampling related programming and data collection is described in the Intel 64 and IA-32 architecture software development manuals. In various examples, the proposed concept is based on a two-component approach. For example, first, both page A/D bit and memory accesses using processor event-based sampling (PEBs) are sampled independently for a target process or virtual machine. Second, one or more hot pages selected from A/D bit tracking are checked against the memory access data from PEBs to make the final determination for page migration. The memory access data from PEBs also helps to determine whether a given large page should be split into small pages for better page migration.

The proposed concept may improve memory tiering scenarios by helping to improve the page selection for migration between memory tiers as well as providing access sparsity information for large pages, which may be used to decide whether a given large page should be broken into small pages.

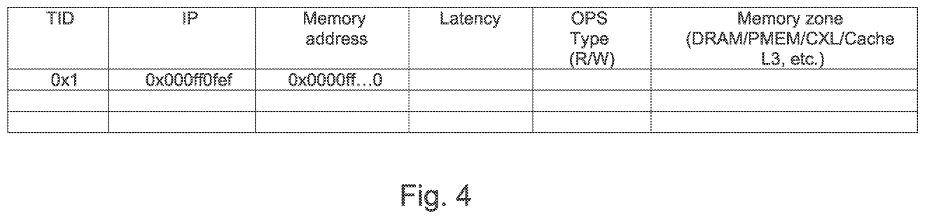

Using the aforementioned processer event-based sample, load/store events of a process/virtual machine running on a particular core may be tracked, e.g., including the latency of the load/store evens, and the pre-configured memory buffers may be filled with information on the memory pages as shown in FIG. 4. FIG. 4 shows a table of potential information to be collected for the respective memory pages. Such a table may include information such as TID, IP, memory address, latency, operation type (read or write) and memory zone/tier (DRAM, PMEM, CXL, Cache L3 etc.). In case the concept is performed with respect to a virtual machine, a small driver in the guest virtual machine can allocate PEBs DS (Debug Store) buffer and make a hyper call to the virtual machine monitor to inform the virtual machine monitor of the address. Alternatively, the VMM can allocate a buffer for each CPU and pass the location to the guest virtual machine for it to program the DS buffer appropriately.

The memory address being collected may be a linear address or the host physical address. In case of using linear addresses, one (PT) or two page tables (EPT, PT) may be queried to get the host physical address. For example, the CPU may be configured to, e.g., using a microcode update, to capture the platform physical address as well for a given memory access. Based on the latency value, accesses can be categorized as being retired at either L1/L2/L3/DRAM/PMEM/CXL, etc. Furthermore, an event can be used to capture L3 miss events for load/store instructions, indicating memory or slower tier being accessed based on page address location. The number of L3 miss events can be subtracted with the total load/store evens to determine all accesses that were in CPU cache hierarchy. For each process, or virtual machine, a data store may be maintained that can answer the following questions for any page that is monitored: a) % of accesses that retired in cache, b) % of accesses that retired in the faster tier (if the page is currently allocated from faster tier), c) % of accesses that retired in the slower tier (if the page is currently allocated in slower tier), and/or a sparseness indicator.

A detailed example of the proposed enhanced and efficient hot and cold page selection for migrating between memory tiers is shown in FIG. 5. For example, the flow of FIG. 5 may be implemented by the apparatus 10 or device 10 shown in connection with FIG. 1a. FIG. 5 shows a schematic diagram of an example flow of hot/cold page selection for migration for memory tiering scenarios. The flow comprises enabling 510 the PEBs for a VM/Process. The PEBs collect 512 memory access data until a PEBs buffer overflow interrupt 514 occurs and the OS/VMM is notified. Then, the page access information is stored 516 in a kernel structured. For the A/D information from the page tables, again, the VM/Process is selected 520, then the PT or EPT A/D bit is scanned/cleared 522 for each entry with the A/D bit set. According to a scanning interval 524 (in seconds), the PT or EPT A/D bit is scanned again 526. If the A/D bit is set, then the PEBs data is queried 530 for the page cache statistics (and optional sparsity indicator), if not, if the scanning is still incomplete, the flow returns to scanning the PT or EPT A/D bit 526, if the scanning is complete, the flow returns to scanning/clearing the PT or EPT A/D bit 522. If, according to the query 530, the page should be migrated between tiers, then the page is migrated 550 between tiers, if not, if the scanning is still incomplete, the flow returns to scanning the PT or EPT A/D bit 526, if the scanning is complete, the flow returns to scanning/clearing the PT or EPT A/D bit 522. For example, the page may be migrated from the slower memory tier to the faster memory tier when the respective page is considered hot (as evidenced by the A/D bit being frequently set and the PEBs). On the other hand, a page may be migrated from the faster memory tier to the slower memory tier when the respective page is considered cold, e.g., when the A/D bis has not been set for a while. Optionally, if the page is to be migrated, and the page is a large page (e.g., a 2M page), the large page may be split 540 into smaller pages (e.g., 4k pages), with one or more of the smaller pages being migrated 550 between tiers.

As shown in FIG. 5, the OS/hypervisor may use two daemons (shown by the flows 510-516 and 520-526)—one for collecting page A/D bit tracking and the other for maintaining the PEBs based memory accesses data store for a given process or virtual machine.

While, e.g., in a first time-interval, scanning the page A/D bit tracking info, if a page currently allocated to a slower tier turns out to be very “hot” then the concept may consult, e.g., in a second time-interval (following the first time interval) the aforementioned PEBs data store to see if the percentage of accesses to the page retiring in cache is smaller than a preconfigured threshold. If this is the case, can be marked for relocation to the faster tier. This approach may thus avoid useless data movement.

Also, With A/D bit tracking, if a large page (2 MB) is currently allocated either to the faster or slower tier and the PEBS data store indicates the page is very sparsely accessed, then the large page can be broken into smaller (4 KB) pages for better data movement in the future.

More details and aspects of the concept for hot and cold page tracking are mentioned in connection with the proposed concept or one or more examples described above or below (e.g., FIG. 1a to 1b). The concept for hot and cold page tracking may comprise one or more additional optional features corresponding to one or more aspects of the proposed concept, or one or more examples described above or below.

In the following, some examples of the proposed concept are presented.

An example (e.g., example 1) relates to an apparatus (10) for managing memory of a computer system (100), the apparatus comprising interface circuitry (12), machine-readable instructions and processing circuitry (14) to obtain first information on accesses to at least one of a first tier of memory (102) and a second tier of memory (104) within a memory hierarchy of the computer system from a page table, the first and second tiers of memory being below the processor cache tiers of the memory hierarchy, the first tier of memory having a higher memory performance than the second tier of memory. The machine-readable instructions comprise instructions to obtain second information on accesses to at least one of the first tier of memory and the second tier of memory from logged processor events related to the accesses to the first tier of memory and the second tier of memory. The machine-readable instructions comprise instructions to select one or more memory pages to be moved between the first tier of memory and the second tier of memory based on the first and second information on the accesses to at least one of the first tier of memory and the second tier of memory.

Another example (e.g., example 2) relates to a previously described example (e.g., example 1) or to any of the examples described herein, further comprising that the first tier of memory is dynamic random-access memory-based memory.

Another example (e.g., example 3) relates to a previously described example (e.g., one of the examples 1 to 2) or to any of the examples described herein, further comprising that the second tier of memory is one or persistent memory, non-volatile memory express-based memory, and compute express link-based memory.

Another example (e.g., example 4) relates to a previously described example (e.g., one of the examples 1 to 3) or to any of the examples described herein, further comprising that the logged processor events comprise information on processor cache hits or misses occurring during accesses to the first tier of memory and the second tier of memory.

Another example (e.g., example 5) relates to a previously described example (e.g., one of the examples 1 to 4) or to any of the examples described herein, further comprising that the logged processor events comprise information on a latency of accesses to memory pages stored in at least one of the first tier of memory and the second tier of memory.

Another example (e.g., example 6) relates to a previously described example (e.g., example 5) or to any of the examples described herein, further comprising that the information on the latency of the accesses to the memory pages reflects cache hits or misses occurring during accesses to at least one of the first tier of memory and the second tier of memory.

Another example (e.g., example 7) relates to a previously described example (e.g., one of the examples 1 to 6) or to any of the examples described herein, further comprising that the first information on the accesses is based on the respective access bits and dirty bits stored in the page table.

Another example (e.g., example 8) relates to a previously described example (e.g., one of the examples 1 to 7) or to any of the examples described herein, further comprising that the machine-readable instructions comprise instructions to move a memory page between the second tier of memory and the first tier of memory based on the selection.

Another example (e.g., example 9) relates to a previously described example (e.g., example 8) or to any of the examples described herein, further comprising that the machine-readable instructions comprise instructions to select the one or more memory pages to be moved between the first tier of memory and the second tier of memory based on at least one of an access frequency of the one or more memory pages, a memory access latency of accesses to the one or more memory pages and a processor cache hit or miss rate of accesses to the one or more memory pages.

Another example (e.g., example 10) relates to a previously described example (e.g., one of the examples 8 to 9) or to any of the examples described herein, further comprising that the machine-readable instructions comprise instructions to select a memory page to be moved from the second tier of memory to the first tier of memory if the first and second information on the accesses indicate the access frequency to the memory page is higher than an access frequency of at least some other memory pages and the processor cache miss rate of accesses to the memory page is higher than a pre-defined cache miss threshold.

Another example (e.g., example 11) relates to a previously described example (e.g., one of the examples 8 to 10) or to any of the examples described herein, further comprising that the machine-readable instructions comprise instructions to select a memory page to be moved from the second tier of memory to the first tier of memory if the first and second information on the accesses indicate the access frequency to the memory page is higher than an access frequency of at least some other memory pages and the memory access latency of accesses to the memory page is higher than a pre-defined latency threshold.

Another example (e.g., example 12) relates to a previously described example (e.g., one of the examples 1 to 11) or to any of the examples described herein, further comprising that a first subset of the memory pages of the memory have a first smaller page size and a second subset of the memory pages of the memory have a second larger page size, the machine-readable instructions comprising instructions to determine a sparseness of accesses to the memory pages having the second larger page size, to split a memory page having the second larger page size into a plurality of memory pages having the first smaller page size based on the sparseness of accesses to the memory page, and to select at least one of the plurality of memory pages having the first smaller page size to be moved between the first tier of memory and the second tier of memory.

Another example (e.g., example 13) relates to a previously described example (e.g., example 12) or to any of the examples described herein, further comprising that the decision on whether to split the memory page having the second larger page size and the selection of the at least one memory page is based on the first and second information on the accesses.

Another example (e.g., example 14) relates to a previously described example (e.g., one of the examples 1 to 13) or to any of the examples described herein, further comprising that the machine-readable instructions comprise instructions to configure a processor (106) of the computer system to log at least one of a memory access latency of accesses to memory pages and a processor cache hit or miss rate of accesses to memory pages.

Another example (e.g., example 15) relates to a previously described example (e.g., example 14) or to any of the examples described herein, further comprising that the machine-readable instructions comprise instructions to configure the processor of the computer system to log at least one of the memory access latency of accesses to memory pages and the processor cache hit or miss rate of accesses to memory pages for a specific computer program being executed by the computer system.

Another example (e.g., example 16) relates to a previously described example (e.g., one of the examples 1 to 15) or to any of the examples described herein, further comprising that the first information and the second information on the accesses relate to accesses of a specific computer program being executed by the computer system.

An example (e.g., example 17) relates to a computer system (100) comprising a first tier of memory (102), a second tier of memory (104) and the apparatus (10) according to one of the examples 1 to 16 or according to any other example.

Another example (e.g., example 18) relates to a previously described example (e.g., example 17) or to any of the examples described herein, further comprising that the first tier of memory is dynamic random-access memory-based memory.

Another example (e.g., example 19) relates to a previously described example (e.g., one of the examples 17 to 18) or to any of the examples described herein, further comprising that the second tier of memory is one or persistent memory, non-volatile memory express-based memory, and compute express link-based memory.

Another example (e.g., example 20) relates to a previously described example (e.g., example 17) or to any of the examples described herein, further comprising that the computer system comprises a processor (106), the machine-readable instructions of the apparatus comprising instructions to configure the processor of the computer system to log at least one of a memory access latency of accesses to memory pages and a processor cache hit or miss rate of accesses to memory pages.

An example (e.g., example 21) relates to an apparatus (10) for managing memory of a computer system (100), the apparatus comprising interface circuitry (12) and processing circuitry (14) configured to obtain first information on accesses to at least one of a first tier of memory (102) and a second tier of memory (104) within a memory hierarchy of the computer system from a page table, the first and second tiers of memory being below the processor cache tiers of the memory hierarchy, the first tier of memory having a higher memory performance than the second tier of memory. The processing circuitry is configured to obtain second information on accesses to at least one of the first tier of memory and the second tier of memory from logged processor events related to the accesses to the first tier of memory and the second tier of memory. The processing circuitry is configured to select one or more memory pages to be moved between the first tier of memory and the second tier of memory based on the first and second information on the accesses to at least one of the first tier of memory and the second tier of memory.

An example (e.g., example 22) relates to a computer system (100) comprising a first tier of memory (102), a second tier of memory (104) and the apparatus (10) according to example 21 or according to any other example.

An example (e.g., example 23) relates to a device (10) for managing memory of a computer system (100), the apparatus comprising means for communicating (12) and means for processing (14) configured to obtain first information on accesses to at least one of a first tier of memory (102) and a second tier of memory (104) within a memory hierarchy of the computer system from a page table, the first and second tiers of memory being below the processor cache tiers of the memory hierarchy, the first tier of memory having a higher memory performance than the second tier of memory. The means for processing is configured to obtain second information on accesses to at least one of the first tier of memory and the second tier of memory from logged processor events related to the accesses to the first tier of memory and the second tier of memory. The means for processing is configured to select one or more memory pages to be moved between the first tier of memory and the second tier of memory based on the first and second information on the accesses to at least one of the first tier of memory and the second tier of memory.

An example (e.g., example 24) relates to a computer system (100) comprising a first tier of memory (102), a second tier of memory (104) and the device (10) according to example 23 or according to any other example.

An example (e.g., example 25) relates to a method for managing memory of a computer system (100), the method comprising obtaining (120) first information on accesses to at least one of a first tier of memory (102) and a second tier of memory (104) within a memory hierarchy of the computer system from a page table, the first and second tiers of memory being below the processor cache tiers of the memory hierarchy, the first tier of memory having a higher memory performance than the second tier of memory. The method comprises obtaining (130) second information on accesses to at least one of the first tier of memory and the second tier of memory from logged processor events related to the accesses to the first tier of memory and the second tier of memory. The method comprises selecting (150) one or more memory pages to be moved between the first tier of memory and the second tier of memory based on the first and second information on the accesses to at least one of the first tier of memory and the second tier of memory.

Another example (e.g., example 26) relates to a previously described example (e.g., example 25) or to any of the examples described herein, further comprising that method comprises moving (160) a memory page between the second tier of memory and the first tier of memory based on the selection.

Another example (e.g., example 27) relates to a previously described example (e.g., example 26) or to any of the examples described herein, further comprising that the method comprises selecting (150) the one or more memory pages to be moved between the first tier of memory and the second tier of memory based on at least one of an access frequency of the one or more memory pages, a memory access latency of accesses to the one or more memory pages and a processor cache hit or miss rate of accesses to the one or more memory pages.

Another example (e.g., example 28) relates to a previously described example (e.g., one of the examples 26 to 27) or to any of the examples described herein, further comprising that the method comprises selecting (150) a memory page to be moved from the second tier of memory to the first tier of memory if the first and second information on the accesses indicate the access frequency to the memory page is higher than an access frequency of at least some other memory pages and the processor cache miss rate of accesses to the memory page is higher than a pre-defined cache miss threshold.

Another example (e.g., example 29) relates to a previously described example (e.g., one of the examples 26 to 28) or to any of the examples described herein, further comprising that the method comprises selecting (150) a memory page to be moved from the second tier of memory to the first tier of memory if the first and second information on the accesses indicate the access frequency to the memory page is higher than an access frequency of at least some other memory pages and the memory access latency of accesses to the memory page is higher than a pre-defined latency threshold.

Another example (e.g., example 30) relates to a previously described example (e.g., one of the examples 25 to 29) or to any of the examples described herein, further comprising that a first subset of the memory pages of the memory have a first smaller page size and a second subset of the memory pages of the memory have a second larger page size, the method comprising determining (140) a sparseness of accesses to the memory pages having the second larger page size, splitting (145) a memory page having the second larger page size into a plurality of memory pages having the first smaller page size based on the sparseness of accesses to the memory page, and selecting (150) least one of the plurality of memory pages having the first smaller page size to be moved between the first tier of memory and the second tier of memory.

Another example (e.g., example 31) relates to a previously described example (e.g., one of the examples 25 to 30) or to any of the examples described herein, further comprising that the method comprises configuring (110) a processor (106) of the computer system to log at least one of a memory access latency of accesses to memory pages and a processor cache hit or miss rate of accesses to memory pages.

Another example (e.g., example 32) relates to a previously described example (e.g., example 31) or to any of the examples described herein, further comprising that the method comprises configuring (110) the processor of the computer system to log at least one of the memory access latency of accesses to memory pages and the processor cache hit or miss rate of accesses to memory pages for a specific computer program being executed by the computer system.

An example (e.g., example 33) relates to a computer system (100) comprising a first tier of memory (102), a second tier of memory (104), the computer system (100) being configured to perform the method according to one of the examples 25 to 32 or according to any other example.

An example (e.g., example 34) relates to a non-transitory machine-readable storage medium including program code, when executed, to cause a machine to perform the method of one of the examples 25 to 32 or according to any other example.

An example (e.g., example 35) relates to a computer program having a program code for performing the method of one of the examples the method of one of the examples 25 to 32 or according to any other example when the computer program is executed on a computer, a processor, or a programmable hardware component.

An example (e.g., example 36) relates to a machine-readable storage including machine readable instructions, when executed, to implement a method or realize an apparatus as claimed in any pending claim or shown in any example.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor, or other programmable hardware component. Thus, steps, operations, or processes of different ones of the methods described above may also be executed by programmed computers, processors, or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations, or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process, or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C #, Java, Perl, Python, JavaScript, Adobe Flash, C #, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present, or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus for managing memory of a computer system, the apparatus comprising interface circuitry, machine-readable instructions and processing circuitry to:
obtain first information on accesses to at least one of a first tier of memory and a second tier of memory within a memory hierarchy of the computer system from a page table, the first and second tiers of memory being below the processor cache tiers of the memory hierarchy, the first tier of memory having a higher memory performance than the second tier of memory;
obtain second information on accesses to at least one of the first tier of memory and the second tier of memory from logged processor events related to the accesses to the first tier of memory and the second tier of memory; and
select one or more memory pages to be moved between the first tier of memory and the second tier of memory based on the first and second information on the accesses to at least one of the first tier of memory and the second tier of memory.

2. The apparatus according to claim 1, wherein the first tier of memory is dynamic random-access memory-based memory.

3. The apparatus according to claim 1, wherein the second tier of memory is one or persistent memory, non-volatile memory express-based memory, and compute express link-based memory.

4. The apparatus according to claim 1, wherein the logged processor events comprise information on processor cache hits or misses occurring during accesses to the first tier of memory and the second tier of memory.

5. The apparatus according to claim 1, wherein the logged processor events comprise information on a latency of accesses to memory pages stored in at least one of the first tier of memory and the second tier of memory.

6. The apparatus according to claim 5, wherein the information on the latency of the accesses to the memory pages reflects cache hits or misses occurring during accesses to at least one of the first tier of memory and the second tier of memory.

7. The apparatus according to claim 1, wherein the first information on the accesses is based on the respective access bits and dirty bits stored in the page table.

8. The apparatus according to claim 1, wherein the machine-readable instructions comprise instructions to move a memory page between the second tier of memory and the first tier of memory based on the selection.

9. The apparatus according to claim 8, wherein the machine-readable instructions comprise instructions to select the one or more memory pages to be moved between the first tier of memory and the second tier of memory based on at least one of an access frequency of the one or more memory pages, a memory access latency of accesses to the one or more memory pages and a processor cache hit or miss rate of accesses to the one or more memory pages.

10. The apparatus according to claim 8, wherein the machine-readable instructions comprise instructions to select a memory page to be moved from the second tier of memory to the first tier of memory if the first and second information on the accesses indicate the access frequency to the memory page is higher than an access frequency of at least some other memory pages and the processor cache miss rate of accesses to the memory page is higher than a pre-defined cache miss threshold.

11. The apparatus according to claim 8, wherein the machine-readable instructions comprise instructions to select a memory page to be moved from the second tier of memory to the first tier of memory if the first and second information on the accesses indicate the access frequency to the memory page is higher than an access frequency of at least some other memory pages and the memory access latency of accesses to the memory page is higher than a pre-defined latency threshold.

12. The apparatus according to claim 1, wherein a first subset of the memory pages of the memory have a first smaller page size and a second subset of the memory pages of the memory have a second larger page size, the machine-readable instructions comprising instructions to determine a sparseness of accesses to the memory pages having the second larger page size, to split a memory page having the second larger page size into a plurality of memory pages having the first smaller page size based on the sparseness of accesses to the memory page, and to select at least one of the plurality of memory pages having the first smaller page size to be moved between the first tier of memory and the second tier of memory.

13. The apparatus according to claim 12, wherein the decision on whether to split the memory page having the second larger page size and the selection of the at least one memory page is based on the first and second information on the accesses.

14. The apparatus according to claim 1, wherein the machine-readable instructions comprise instructions to configure a processor of the computer system to log at least one of a memory access latency of accesses to memory pages and a processor cache hit or miss rate of accesses to memory pages.

15. The apparatus according to claim 14, wherein the machine-readable instructions comprise instructions to configure the processor of the computer system to log at least one of the memory access latency of accesses to memory pages and the processor cache hit or miss rate of accesses to memory pages for a specific computer program being executed by the computer system.

16. The apparatus according to claim 1, wherein the first information and the second information on the accesses relate to accesses of a specific computer program being executed by the computer system.

17. A computer system comprising a first tier of memory, a second tier of memory and the apparatus according to claim 1.

18. The computer system according to claim 17, wherein the first tier of memory is dynamic random-access memory-based memory.

19. The computer system according to claim 17, wherein the second tier of memory is one or persistent memory, non-volatile memory express-based memory, and compute express link-based memory.

20. The computer system according to claim 17, wherein the computer system comprises a processor, the machine-readable instructions of the apparatus comprising instructions to configure the processor of the computer system to log at least one of a memory access latency of accesses to memory pages and a processor cache hit or miss rate of accesses to memory pages.

21. A method for managing memory of a computer system, the method comprising:
obtaining first information on accesses to at least one of a first tier of memory and a second tier of memory within a memory hierarchy of the computer system from a page table, the first and second tiers of memory being below the processor cache tiers of the memory hierarchy, the first tier of memory having a higher memory performance than the second tier of memory;
obtaining second information on accesses to at least one of the first tier of memory and the second tier of memory from logged processor events related to the accesses to the first tier of memory and the second tier of memory; and
selecting one or more memory pages to be moved between the first tier of memory and the second tier of memory based on the first and second information on the accesses to at least one of the first tier of memory and the second tier of memory.

22. A non-transitory machine-readable storage medium including program code, when executed, to cause a machine to perform the method of claim 21.
